(19) United States
(12) Patent Application Publication
(10) Pub. No.: US 2011/0235604 A1
(43) Pub. Date: Sep. 29, 2011

(54) COMMUNICATION SYSTEM, COMMUNICATION METHOD, BASE STATION, MOBILE STATION, AND PROGRAM

(75) Inventors: Takamichi Inoue, Tokyo (JP); Yoshikazu Kakura, Tokyo (JP)

(73) Assignee: NEC CORPORATION, Tokyo (JP)

(21) Appl. No.: 13/131,091

(22) PCT Filed: Nov. 24, 2009
(86) PCT No.: PCT/JP2009/069812

§ 371 Date: May 25, 2011

(30) Foreign Application Priority Data
Nov. 25, 2008 (JP) 2008-299044

(51) Int. Cl. H04W 72/04; H04W 40/00

(52) U.S. Cl. 370/329; 370/328

(57) ABSTRACT

Provided is a technique for efficiently selecting access schemes for use in communications. This invention includes an identifying means that identifies, from station-on-the-other-end candidate information, which is control information in which information related to an access scheme corresponding to each of a plurality of stations-on-the-other-end of communication is described, and from information related to an access scheme corresponding to the local station, access schemes beforehand one of which can be used in communication with a communication partner station; and a selecting means that selects, as the access scheme to be used in data communication with a communication partner station, one of the identified access schemes when the data communication is started.

### TECHNICAL FIELD

The present invention relates to a technology for determining an access scheme used in data communication in a wireless communication system in which multiple access schemes can be used.

### BACKGROUND ART

The SC-FDMA (Single Carrier-Frequency Division Multiplexing Access) is adopted as an access scheme for uplinks of LTE (Long Term Evolution) standardized by the 3GPP (3rd Generation Partnership Project). (In case of transmitter configuration in which subcarrier mapping is carried out in the frequency domain, it is also designated as DFT-s-OFDM (Discrete Fourier Transform-spread-Orthogonal Frequency Division Multiplexing).) One of the reasons for this is that it is low in PAPR (Peak to Average Power Ratio) and its coverage can be increased.

It is known that in environments in which a propagation path is subjected to frequency selective fading, throughput can be enhanced by carrying out frequency-domain channel-dependent scheduling. In frequency-domain channel-dependent scheduling, a resource block (RB) is allocated to a mobile station excellent in propagation path quality in the frequency domain. A resource block is comprised of multiple subcarriers and in case of LTE, one resource block is comprised of 12 subcarriers. In resource block mapping in SC-FDMA, resource blocks continuous on a frequency axis are allocated to each mobile station in one TTI.

Standardization for LTE-A (LTE-Advanced) in which communication speed of 1 Gbps or so for downlinks and 500 Mbps or so for uplinks is achieved has been started under the 3GPP. A bandwidth wider than 20 MHz for LTE will be probably supported.

Consideration is presently given to applying OFDM (Orthogonal Frequency Division Multiplex) as an uplink access scheme under the LTE-A supporting a wider bandwidth. The OFDM is excellent in resistance to frequency selective fading and is especially suitable for application to high-order modulation and MIMO. The OFDM in which resource blocks discontinuous on a frequency axis can be allocated is higher in the degree of freedom in resource allocation than SC-FDMA in which continuous resource blocks are allocated; therefore, the greater multiuser diversity effect can be expected.

However, the OFDM involves a problem of high PAPR. To achieve the same coverage as LTE in LTE-A supporting a wide bandwidth, it is necessary to increase transmission power in proportion to bandwidth. In OFDM larger in CM (Cubic Metric) than SC-FDMA, further increase in transmission power density is required to achieve the same cell coverage as in LTE.

In standardization of the LTE-A, consequently, it is proposed to change uplink access schemes according to the communication environment or the like. For example, this change is carried out between SC-FDMA and OFDM (NPL 1 and 2).

Hereafter, description will be given to two systems for change between SC-FDMA and OFDM.

FIG. 1 illustrates a system in which a mobile station changes access schemes according to the access schemes supported by a cell, that is, a base station. The access scheme used by mobile stations in one and the same cell is common.

The base station 1 in FIG. 1 communicates with mobile stations 1, 2 and the base station 2 communicates with mobile stations 3, 4. The cell supported by the base station 1 is a macro cell large in size. Mobile stations located at the cell end are brought into a state in which transmission power is insufficient (power-limited environment). For this reason, the base station 1 uses SC-FDMA low in PAPR to communicate. Therefore, the mobile stations 1, 2 use SC-FDMA to communicate with the base station 1. Meanwhile, the cell supported by the base station 2 is a micro cell small in size and even mobile stations located at the cell end have sufficient transmission power. For this reason, the base station 2 uses OFDM in which the great multiuser diversity effect can be expected to communicate. Therefore, the mobile stations 3, 4 use OFDM to communicate with the base station 2.

FIG. 2 illustrates a system in which access schemes are changed from mobile station to mobile station. As a result, mobile stations using different access schemes exist together in one and the same cell.

The base station 3 in FIG. 2 communicates with mobile stations 5 to 8. In this case, each mobile station can use the most appropriate access scheme according to the communication environment. For example, when a mobile station (mobile stations 5, 8) is located at the cell end where transmission power is insufficient, it uses SC-FDMA low in PAPR to communicate. When a mobile station (mobile stations 6, 7) is located in the vicinity of the base station 3 where transmission power sufficient, it uses OFDM in which the greater multiuser diversity effect can be expected to communicate.

One of the required conditions for the LTE-A system is that each LTE-A base station should also support LTE mobile stations compatible with the access scheme of SC-FDMA. That is, the LTE mobile station is required that it can communicate both in the cell of an LTE-A base station and in the cell of an LTE base station without problems.

### CITATION LIST

### Non Patent Literature

NPL 1: 3GPP R1-081752 NEC, “Proposals on PHY related aspects in LTE Advanced”

NPL 2: 3GPP R1-081791 Panasonic, “Technical proposals and considerations for LTE advanced”

### SUMMARY OF INVENTION

### Technical Problem

In case of systems in which access schemes are changed from mobile station to mobile station, in general, the following measure can be taken: each mobile station transmits information on the changed access schemes each time access schemes are changed. As an example, it will be assumed that there are two different access schemes to be changed. In this case, the following takes place when PDCCH (Physical Downlink Control CHannel) as a down control signal is used to transmit information on changed access schemes: one bit is required for each mobile station and a PDCCH resource for transmitting the number of mobile stations multiplexed in one TTI×1 bit is newly required for each TTI. When the number of kinds of changed access schemes is increased, the number of bits is also increased according to the kinds.

The LTE-A base station is also required to support LTE mobile stations compatible with the access scheme of SC-FDMA. In standardization of LTE-A, therefore, any modification that has influence on the operation of the LTE mobile station compatible with the present LTE specifications is not permitted.

The problem to be solved by the present invention is to provide a technology for efficiently determining access schemes used in communication.

### Solution to Problem

The present invention for solving the above problem is a communication system characterized in that using partner station candidate information that is control information in which information pertaining to access schemes with which a communication partner station is compatible is described, access schemes that can be used with said communication partner station are identified beforehand and any of said identified access schemes is determined during data communication as an access scheme to be used in said data communication with said communication partner station.

The present invention for solving the above problem is a terminal characterized in that using base station candidate information that is control information in which information pertaining to access schemes with which a base station is compatible is described, access schemes that can be used with said base station are identified beforehand, and using any access scheme of said identified access schemes, which is determined during data communication, data communication with said base station is carried out.

The present invention for solving the above problem is a base station characterized in that using mobile station candidate information that is control information in which information pertaining to access schemes with which a mobile station is compatible is described, access schemes that can be used with said mobile station are identified beforehand, and using any access scheme of said identified access schemes, which is determined during data communication, data communication with said mobile station is carried out.

The present invention for solving the above problem is a communication method characterized in that using partner station candidate information that is control information in which information pertaining to access schemes with which a communication partner station is compatible is described, access schemes that can be used with said communication partner station are identified beforehand, and any of said identified access schemes is determined during data communication as an access scheme to be used in said data communication with said communication partner station.

The present invention for solving the above problem is a program of a terminal, characterized in that said program causes said terminal to function to, using base station candidate information that is control information in which information pertaining to access schemes with which a base station is compatible is described, identify beforehand access schemes that can be used with said base station, and using any access scheme of said identified access schemes, which is determined during data communication, carry out data communication with said base station.

The present invention for solving the above problem is a program of a base station, characterized in that said program causes said base station to function to, using mobile station candidate information that is control information in which information pertaining to access schemes with which a mobile station is compatible is described, identify beforehand access schemes that can be used with said mobile station, and using any access scheme of said identified access schemes, which is determined during data communication, carry out data communication with said mobile station.

### ADVANTAGEOUS EFFECTS OF INVENTION

The effect of the present invention is to reduce the overhead of control information required when access schemes are changed in a system in which access schemes are changed from mobile station to mobile station.

### BRIEF DESCRIPTION OF DRAWINGS

FIG. 1 is a drawing illustrating a communication system in which access schemes are changed from base station to base station;

FIG. 2 is a drawing illustrating a communication system in which access schemes are changed from mobile station to mobile station;

FIG. 3 is a block diagram illustrating main components of a base station in a communication system in a first embodiment;

FIG. 4 is a block diagram illustrating main components of a mobile station in a communication system in the first embodiment;

FIG. 5 is a drawing illustrating the flow of operation of a base station and a mobile station in the first embodiment;

FIG. 6 is a drawing illustrating an MCS table in Example 1 in the first embodiment;

FIG. 7 is a drawing illustrating an MCS table in Example 1 in the first embodiment;

FIG. 8 is a drawing illustrating an MCS table in Example 2 in the first embodiment;

FIG. 9 is a block diagram illustrating main components of a base station in a mobile communication system to which a second embodiment is applied;

FIG. 10 is a drawing illustrating the flow of operation of a base station and a mobile station in the second embodiment;

FIG. 11 is a drawing explaining notification indicating the positions on the frequency axis of resource blocks allocated to access schemes in the second embodiment;

FIG. 12 is a drawing illustrating an MCS table in Example 4 in the second embodiment;

FIG. 13 is a drawing explaining notification indicating the positions on the time axis of resource blocks allocated to access schemes in a third embodiment;

FIG. 14 is a drawing illustrating access scheme candidates; and

FIG. 15 is a drawing illustrating the flow of operation of a base station and a mobile station in a fifth embodiment.

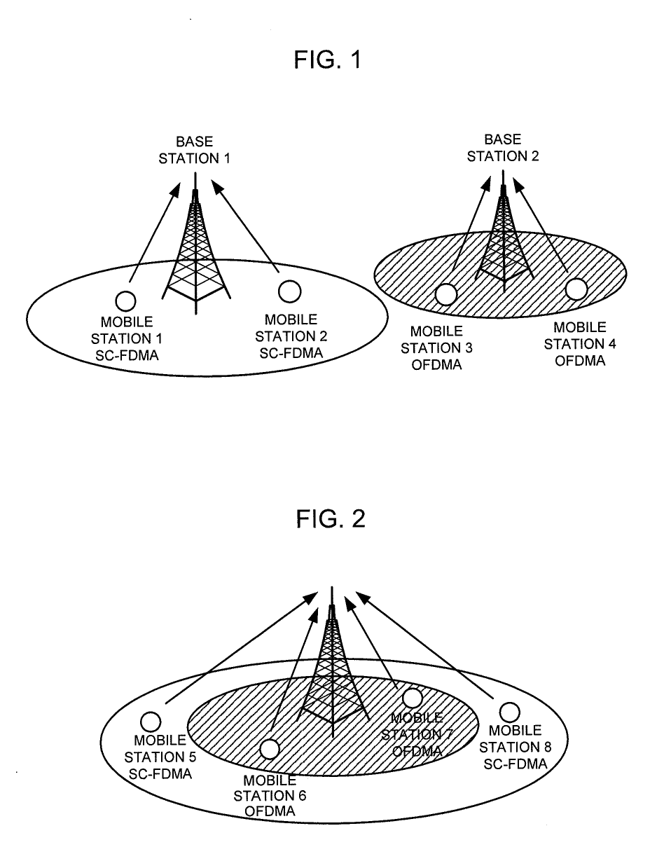

### REFERENCE SIGNS LIST

200 Base station

300 Mobile station

### DESCRIPTION OF EMBODIMENTS

The present invention is characterized in that access schemes used in communication between a mobile station and a base station are identified by each other before data communication is carried out. This identification is carried out based on the following information: broadcast information usually notified to stations-on-the-other-end and control information notified to individual mobile stations.

Description will be given to identification of access schemes in the present invention with reference to the drawings. The following description is based on the assumption that: LTE-A base stations and mobile stations support SC-FDMA and OFDM as access schemes and LTE base stations and mobile stations support SC-FDMA.

### First Embodiment

The first embodiment of the present invention is characterized in that access schemes are changed by a mobile station carrying out the following processing: it reads a modulation scheme and an encoding ratio (MCS: Modulation and Coding Scheme) commonly broadcast from the base station to the mobile stations (UE) in one and the same cell and thereby identifies access schemes used in data communication.

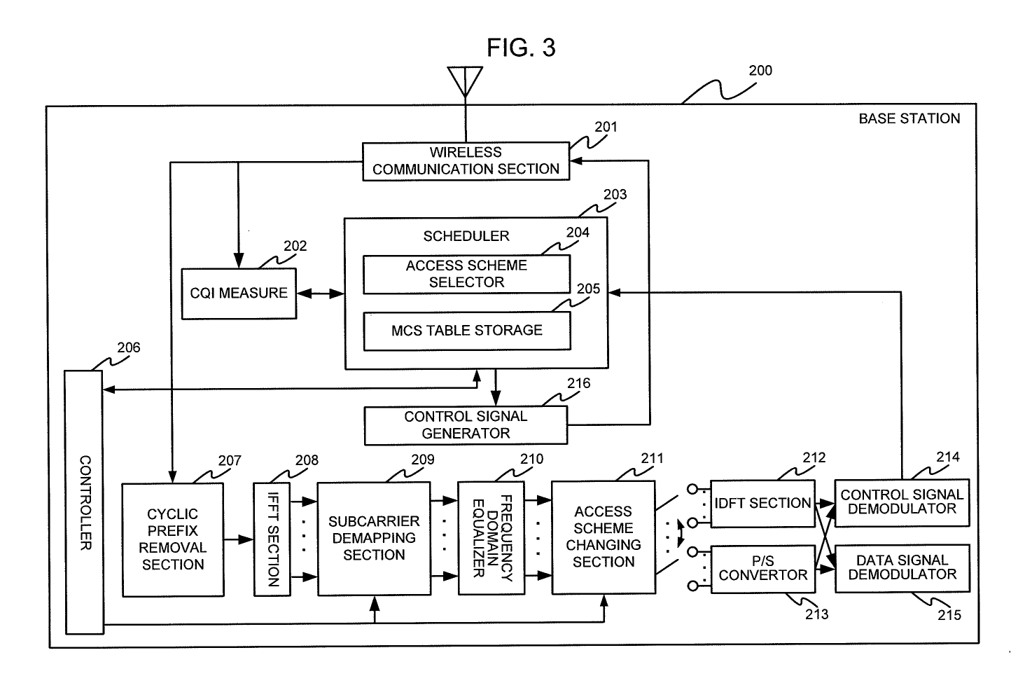

FIG. 3 is a block diagram schematically illustrating the configuration of an LTE-A base station in a mobile wireless system in the first embodiment of the present invention.

The wireless communication section 201 of the base station 200 receives reference signals, control signals, and data signals from mobile stations. It then outputs the reference signals to a CQI measure 202 and the control signals and the data signals to a cyclic prefix removal section 207. Among the reference signals, there are demodulation reference signal used in data demodulation and sounding reference signal used in measurement of the CQI of uplinks, link adaptation and the like.

The CQI measure 202 carries out CQI measurement using a sounding reference signal acquired from the wireless communication section 201 in accordance with a request for measurement of the CQI of a mobile station specified by a scheduler 203. Then it returns the measured CQI value to the scheduler 203.

The scheduler 203 has an access scheme selector 204 and an MCS table storage 205. The access scheme selector 204 determines access schemes from among access scheme candidates that can be used in communication with the mobile station based on the following under the control of a controller 206: a CQI measurement value, a target value for power control, a power head room, MCS, a number of transmission streams, and the like. Further, it refers to the MCS table storage 205 for an MCS table uniquely determined by an access scheme candidate or a combination of access scheme candidates and selects MCS based on the following: the CQI measurement value, the target value for power control, the power head room, a number of allocated resource blocks, the number of transmission streams, and the like. Then it outputs MCS control information that uniquely identifies the MCS to a control signal generator 216. The scheduler 203 carries out resource block allocation corresponding to the determined access schemes and outputs this resource allocation information to the control signal generator 216. In each MCS table stored in the MCS table storage 205, control information that uniquely identifies MCSs and MCSs indicating modulation schemes and encoding ratios are brought into correspondence with each other. This MCS table is prepared according to an access scheme candidate or a combination of access scheme candidates.

The control signal generator 216 generates a control signal containing MCS control information and resource allocation information for the mobile station and transmits it to the mobile station through the wireless communication section 201. Further, it generates a control signal for broadcasting base station-side candidate information indicating the access schemes the own-station supports to each mobile station and transmits it through the wireless communication section 201.

The controller 206 carries out operation control on the entire base station. For example, scheduling by the scheduler 203 is carried out under the control of the controller 206. In general, the controller 206 carries out varied control, such as resource allocation control, by executing a control program on a program control processor.

The cyclic prefix removal section 207 removes the cyclic prefixes of the control signal and data signal outputted from the wireless communication section 201 and outputs them to an IFFT section 208.

The IFFT section 208 transforms the control signal and data signal outputted from the cyclic prefix removal section 207 into a signal in the frequency domain.

A subcarrier demapping section 209 returns mapped subcarriers to the original state using subcarrier mapping information inputted from the controller 206.

A frequency domain equalizer 210 carries out frequency domain equalization to compensate amplitude fluctuation and phase fluctuation due to fading in a propagation path.

An access scheme changing section 211 changes the circuitry so that the following is implemented: data is outputted to an IDFT section 212 when information pertaining to access schemes inputted from the controller 206 indicates SC-FDMA and is outputted to a parallel/serial convertor (P/S section) 213 when it indicates OFDM.

The IDFT section 212 converts the inputted signal into a signal in the time domain and the P/S section 213 converts the inputted signal in a parallel signal. Control signals are outputted to a control signal demodulator 214 and data signals are outputted to a data signal demodulator 215.

The control signal demodulator 214 demodulates control signals and outputs them to the scheduler 203. Meanwhile, the data signal demodulator 215 demodulates data signals.

Description will be given to the configuration of the LTE base station. The configuration of the LTE base station is different from the above base station compatible with LTE-A in that: the blocks of the access scheme selector 204, the access scheme changing section 211, and the P/S convertor 213 are not provided. The MCS table storage 205 stores only one MCS table corresponding to SC-FDMA. The other configuration elements are the same as those of the LTE-A base station and the description thereof will be omitted.

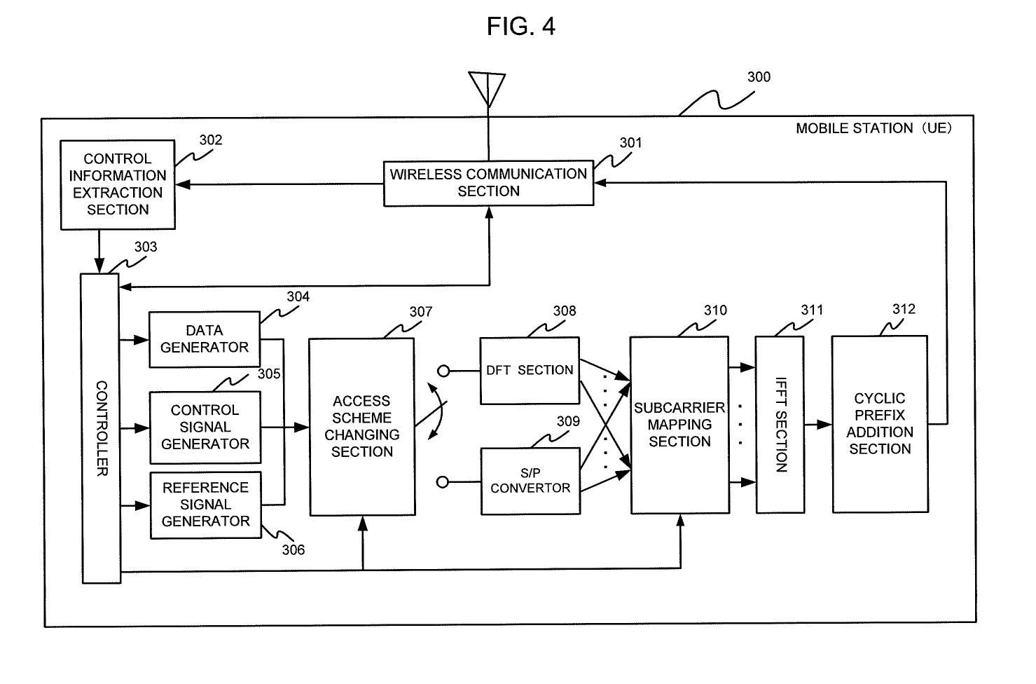

FIG. 4 is a block diagram schematically illustrating the configuration of a mobile station compatible with LTE-A in a mobile wireless system in the first embodiment of the present invention.

In FIG. 4, the wireless communication section 301 of the mobile station 300 demodulates a down control signal and/or down data received from a base station 200 and outputs the demodulated control signal to a control information extraction section 302. The control information extraction section 302 extracts resource allocation information and outputs it to a controller 303.

The controller 303 controls a data generator 304, a control signal generator 305, a reference signal generator 306, an access scheme changing section 307, and a subcarrier mapping section 310, respectively, in accordance with the resource allocation information. The controller 303 holds multiple MCS tables and MCS tables are prepared according to the combinations of access scheme candidates. In each MCS table, control information that uniquely identifies MCSs and MCSs indicating a modulation scheme and an encoding ratio are brought into correspondence with each other. Based on control information on MCS notified from a base station, the mobile station reads MCS brought into correspondence with this control information and notifies the subcarrier mapping section 310 of it. The controller 303 selects an MCS table uniquely determined by the candidates of access schemes that can be used between both the stations. In communication with the base station, the controller refers to the selected MCS table to read MCS. In the initial access, the controller transmits mobile station-side candidate information indicating access schemes the own-station supports to the base station. Thereafter, it confirms whether or not base station-side candidate information indicating access schemes the base station supports is transmitted from the base station.

When initially accessing the base station, the control signal generator 305 generates information indicating access schemes the own-station supports. The data, control signal, and reference signal generated by the data generator 304, control signal generator 305, and reference signal generator 306 are outputted to the access scheme changing section 307. Under the control of the controller 303, the access scheme changing section 307 does output to a DFT (Discrete Fourier Transform) section 308 when the access scheme is SC-FDMA and to an S/P (Serial/Parallel) convertor 309 when it is OFDM.

An SC-FDMA signal is converted into a signal in the frequency domain by the DFT section 308 and an OFDM signal is converted into a parallel signal by the S/P convertor 309. Thereafter, each signal is outputted to the subcarrier mapping section 310. The subcarrier mapping section 310 selects which signal in the frequency domain should be transmitted in accordance with resource allocation information and MCS information from the controller 303. The subcarrier-mapped signal in the frequency domain is converted into a signal in the time domain by an IFFT (Inverse Fast Fourier Transform) section 311 and has a cyclic prefix (CP) added at a cyclic prefix addition section 312. The data, control signal, and reference signal thus outputted from the cyclic prefix addition section 312 are transmitted to the base station 200 through the wireless communication section 301.

Description will be given to the configuration of the LTE mobile station. The configuration of the LTE mobile station is different from the configuration of the above LTE-A mobile station in that: the access scheme changing section 307 and the S/P convertor 309 are not provided. In addition, the control signal generator 305 does not generate information indicating access schemes with which the own mobile station is compatible. Further, the controller 303 holds one MCS table corresponding to SC-FDMA.

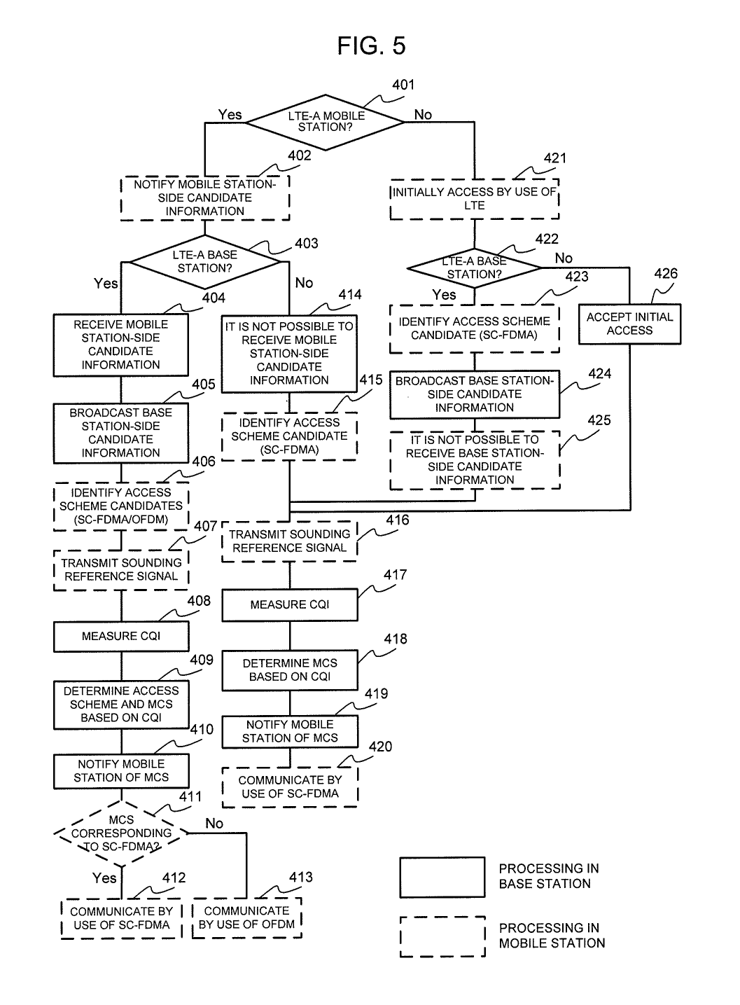

FIG. 5 illustrates the flow of operation of a base station and a mobile station in the first embodiment of the present invention.

First, description will be given to a case where an LTE-A mobile station communicates with a base station (Yes at Step 401).

When initially accessing the base station, the LTE-A mobile station generates mobile station-side candidate information at its control signal generator 305. The mobile station-side candidate information indicates access schemes (SC-FDMA, OFDM) with which the own mobile station (using, for example, PRACH (Physical Random Access CHannel)) is compatible. Then the LTE-A mobile station notifies the base station of this information (Step 402). The mobile station-side candidate information need not be information indicating access schemes with which the relevant station is compatible. It may be information from which access schemes with which the mobile station is compatible is known, for example, information pertaining to mobile station class, the version of the system the mobile station can support, or the like. Hereafter, description will be given to a case where the base station is an LTE-A base station (Yes at Step 403).

The scheduler 203 of the LTE-A base station receives mobile station-side candidate information transmitted (broadcast) in the initial accessing. Then it identifies access schemes that can be used in communication between both the stations from this information and access schemes which itself can support and selects any one from among multiple MCS tables held by it (Step 404). In this example, the candidates of access schemes that can be used in communication between both the stations are SC-FDMA and OFDM and the LTE-A base station selects an MCS table thereby uniquely determined.

Subsequently, the LTE-A base station generates base station-side candidate information indicating access schemes with which the LTE-A base station is compatible at the control signal generator 216. Then it broadcasts this information using PBCH (Physical Broadcast CHannel) or Higher layer signaling (mapped to PDSCH (Physical Downlink Shared CHannel) in the physical channel) (Step 405). The base station-side candidate information need not be information indicating access schemes with which the relevant base station is compatible. It may be information from which access schemes with which the base station is compatible is known, for example, information pertaining to the version of the system the base station supports or the like.

The controller 303 of the LTE-A mobile station identifies the candidates of access schemes that can be used in communication between both the stations from the following: access schemes which itself can support and the base station-side candidate information transmitted by the LTE-A base station at Step 405. Then it selects any one from among multiple MCS tables it holds (Step 406). In this example, the candidates of access schemes that can be used in communication between both the stations are SC-FDMA and OFDM and the LTE-A mobile station selects an MCS table thereby uniquely determined.

When the LTE-A mobile station transmits data to the base station, it generates a sounding reference signal at the reference signal generator 306 and transmits it to the LTE-A base station (Step 407). The CQI measure 202 of the LTE-A base station receives the sounding reference signal from the LTE-A mobile station and measures the CQI of the LTE-A mobile station (Step 408).

The access scheme selector 204 of the LTE-A base station determines access schemes from the CQI measured by the CQI measure 202 at Step 407. The scheduler 203 determines the CQI and MCS (modulation scheme and encoding ratio) and outputs MCS control information using the MCS table selected at Step 404 (Step 409). At this time, the controller 206 controls the access scheme changing section 211 according to the determined access scheme. That is, it controls the access scheme changing section 211 to change the circuitry so that the following is implemented: data is outputted to the IDFT section 212 when SC-FDMA is used and is outputted to the P/S convertor 213 when OFDM is used.

The control signal generator 216 of the LTE-A base station generates MCS control information in which control information on the MCS determined at Step 409 is described and notifies the LTE-A mobile station of it (Step 410).

The controller 303 of the LTE-A mobile station determines whether or not the received MCS control information is MCS corresponding to SC-FDMA using the received MCS control information and the MCS table selected at Step 406 (Step 411).

When an affirmative judgment is made at Step 411, the controller 303 controls the access scheme changing section 307 so that data is outputted to the DFT section 308 and transmits data by SC-FDMA (Step 412). Meanwhile, when a negative judgment is made at Step 411, the controller 303 controls the access scheme changing section 307 so that data is outputted to the S/P convertor 309 and transmits data by OFDM (Step 413).

Description will be given to a case where the base station is an LTE base station (No at Step 403).

The LTE base station does not carry out the processing of extracting mobile station-side candidate information contained in the signal transmitted in the initial accessing of the LTE-A mobile station (Step 414).

The LTE base station does not broadcast base station-side candidate information. Therefore, the controller 303 of the LTE-A mobile station that cannot receive the information identifies that it is located in the cell of the LTE base station. That is, it identifies that the access scheme candidate is SC-FDMA. Then it selects an MCS table corresponding to SC-FDMA from among the multiple MCS tables it holds. Further, it controls the access scheme changing section 307 so that data is outputted to the DFT section 308 (Step 415).

When the LTE-A mobile station transmits data, it generates a sounding reference signal at the reference signal generator 306 and transmits it (Step 416). The CQI measure 202 of the LTE base station receives the sounding reference signal from the LTE-A mobile station and measures CQI (Step 417).

The scheduler of the LTE base station determines MCS based on the MCS table of LTE using the CQI measured at Step 417 (Step 418).

The control signal generator 216 of the LTE base station generates MCS information in which the MCS determined at Step 418 is described and notifies the LTE-A mobile station of it (Step 419).

Last, the control information extraction section 302 of the LTE-A mobile station extracts the received MCS control signal. Then it transmits data by SC-FDMA using a modulation scheme and an encoding ratio brought into correspondence with the extracted MCS control signal (Step 420).

Description will be given to a case where an LTE mobile station communicates with a base station (No at Step 401).

The LTE mobile station accesses the base station in the initial accessing (Step 421). Description will be given to a case where the base station is an LTE-A base station (Yes at Step 422).

The scheduler 203 of the LTE-A base station receives a signal transmitted in the initial accessing of the LTE mobile station. Since mobile station-side candidate information is not contained in the signal, it identifies that the communication partner station is an LTE mobile station, that is, the access scheme candidate is SC-FDMA. Then it selects an MCS table corresponding to SC-FDMA from among the multiple MCS tables it holds. Further, the controller 206 controls the access scheme changing section 211 to change the circuitry so that data is outputted to the IDFT section 212 (Step 423).

The control signal generator 216 of the LTE-A base station generates base station-side candidate information in which access scheme candidates with which the LTE-A base station is compatible is described and broadcasts it to the mobile stations in its cell (Step 424).

The LTE mobile station cannot extract the signal broadcast by the LTE-A base station at Step 424 (Step 425).

Subsequently, the above-mentioned processing of Steps 416 to 420 is carried out.

Description will be given to a case where an LTE mobile station is located in the cell of an LTE base station (No at Step 422). In this case, communication is carried out between LTE stations and the LTE base station receives a signal transmitted in the initial accessing of the LTE mobile station. The above-mentioned processing of Steps 416 to 420 is carried out.

In the above description, cases where an LTE-A mobile station transmits mobile station-side candidate information in the initial accessing have been taken as examples. Instead, mobile station-side candidate information can be transmitted before data is transmitted, for example, at the time of scheduling requesting, at the time of handover, or the like.

Description will be given to how the candidates of access schemes used between both stations are identified when a base station and a mobile station are compatible with LTE-A or LTE with reference to FIG. 14.

As shown in FIG. 14, the access scheme candidate of an LTE-A mobile station located in the cell of an LTE-A base station is SC-FDMA and OFDM. Meanwhile, the access scheme candidate of an LTE mobile station located in the cell of an LTE-A base station is SC-FDMA because the LTE mobile station supports SC-FDMA. The access scheme candidate of an LTE-A mobile station and an LTE mobile station located in the cell of an LTE base station is SC-FDMA because the LTE base station supports SC-FDMA. That is, the access scheme candidate is SC-FDMA in all the cases other than cases where an LTE-A base station and an LTE-A mobile station communicate with each other.

### EXAMPLE 1

Hereafter, description will be given to examples of the first embodiment. In the MCS tables used in this example, an identical MCS index is not used when the access scheme candidates are different; therefore, a mobile station can identify the access scheme by MCS. In Example 1, the number of MCS indexes is fixed between access scheme candidates. With respect to an access scheme and MCS common to access scheme candidates, an identical MCS index and MCS are brought into correspondence with each other. Between different access schemes, different MCS indexes and MCSs are brought into correspondence with each other.

First, description will be given to a case where an LTE-A mobile station and an LTE-A base station communicate with each other.

In this case, as shown in FIG. 14, the access scheme candidate is SC-FDMA and OFDM. In Example 1, SC-FDMA is used in transmission at a low transmission rate and OFDM is used in transmission at a high transmission rate.

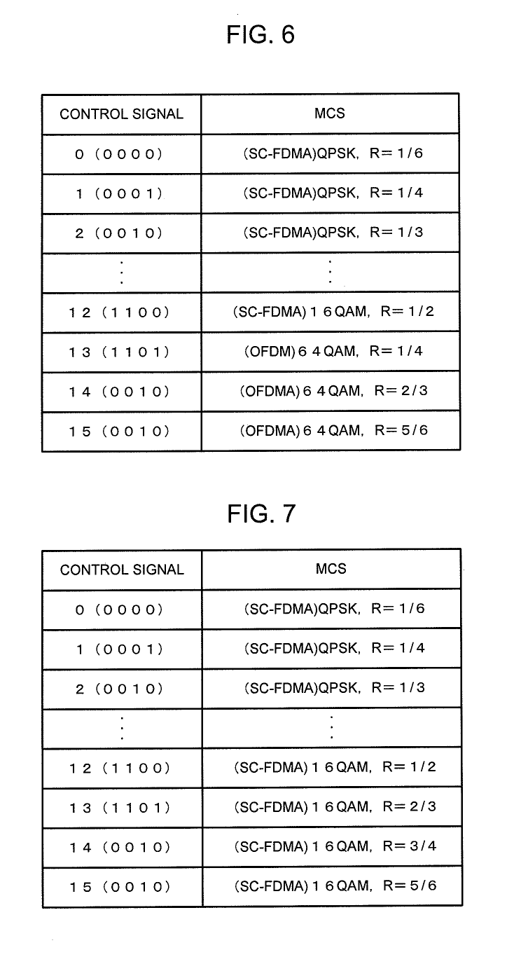

FIG. 6 and FIG. 7 illustrate MCS tables used in Example 1 of the first embodiment. In this example, it is assumed that MCSs in which the control signal is in 16 stages (4 bits) from 0 to 15 are used. When the LTE-A base station and the LTE-A mobile station identify that the access scheme candidate is SC-FDMA and OFDM, such an MCS table corresponding to SC-FDMA and OFDM as shown in FIG. 6 is uniquely selected. When the LTE-A base station determines to use SC-FDMA to communicate, it notifies any of MCS control signals 0 to 12; and when it determines to use OFDM to communicate, it notifies any of MCS control signals 13 to 15. In response thereto, the LTE-A mobile station transmits uplink data using SC-FDMA when the MCS control signal is any of 0 to 12 and using OFDM when it is any of 13 to 15.

Description will be given to a case where the communication is not between an LTE-A mobile station and an LTE-A base station.

In this case, as shown in FIG. 14, the access scheme candidate of the mobile station is SC-FDMA. Therefore, such an MCS table used in LTE as illustrated in FIG. 7 is used.

### EXAMPLE 2

Description will be given to Example 2 of the first embodiment. In the MCS table used in Example 2, as in Example 1, an identical MCS index is not used when access scheme candidates are different. For this reason, a mobile station can identify access schemes by MCS control information. In Example 2, the number of MCS indexes is not constant between access scheme candidates. With respect to an access scheme and MCS common to access scheme candidates, an identical MCS index and MCS are brought into correspondence with each other. Between different access schemes, different MCS indexes are used.

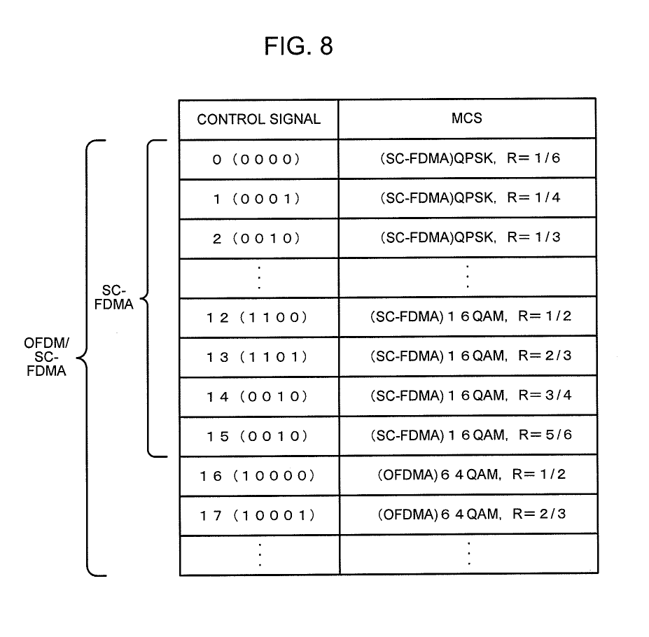

First, description will be given to a case where an LTE-A mobile station and an LTE-A base station communicate with each other. In this case, as shown in FIG. 14, the access scheme candidate is SC-FDMA and OFDM. When the LTE-A base station and the LTE-A mobile station identify that the access scheme candidate is SC-FDMA and OFDM, such an MCS table corresponding to SC-FDMA and OFDM as shown in FIG. 8 is uniquely selected. This description is based on the assumption that MCS control signals in 32 stages (5 bits) from 0 to 31 are used. When the LTE-A base station determines to use SC-FDMA to communicate, it notifies any of control signals 0 to 15 of the same MCS as in the MCS table (FIG. 7) of LTE; and when it determines to use OFDM to communicate, it notifies any of MCS control signals 16 to 31. In response thereto, the LTE-A mobile station uses SC-FDMA when the MCS control signal is any of 0 to 15. Meanwhile, it uses OFDM when the MCS control signal is any of 16 to 31.

Description will be given to a case where the communication is not between an LTE-A mobile station and an LTE-A base station. In this case, as shown in FIG. 14, the access scheme candidate of the mobile station is SC-FDMA. Therefore, the MCS table (FIG. 7) is used and the mobile station extracts a 4-bit MCS control signal indicating any of 0 to 15.

Use of the first embodiment makes it possible to change access schemes without change to MCS notification by LTE. Therefore, even in equipment so configured that either of a base station and a mobile station uses a single access scheme to communicate, communication can be carried out without problems.

Broadcast information minimum necessary for changing access schemes from mobile station to mobile station and down control information usually notified to individual mobile stations are brought into correspondence with each other to change access schemes. For this reason, any special notification pertaining to a new access scheme is not required and thus overhead can be reduced.

### Second Embodiment

In the second embodiment, a base station presets the position of a resource block allocated to each access scheme and a mobile station determines an access scheme from the position of the allocated resource block. The scheduler 203 of the base station takes the access scheme of each mobile station into account when it allocates a resource block.

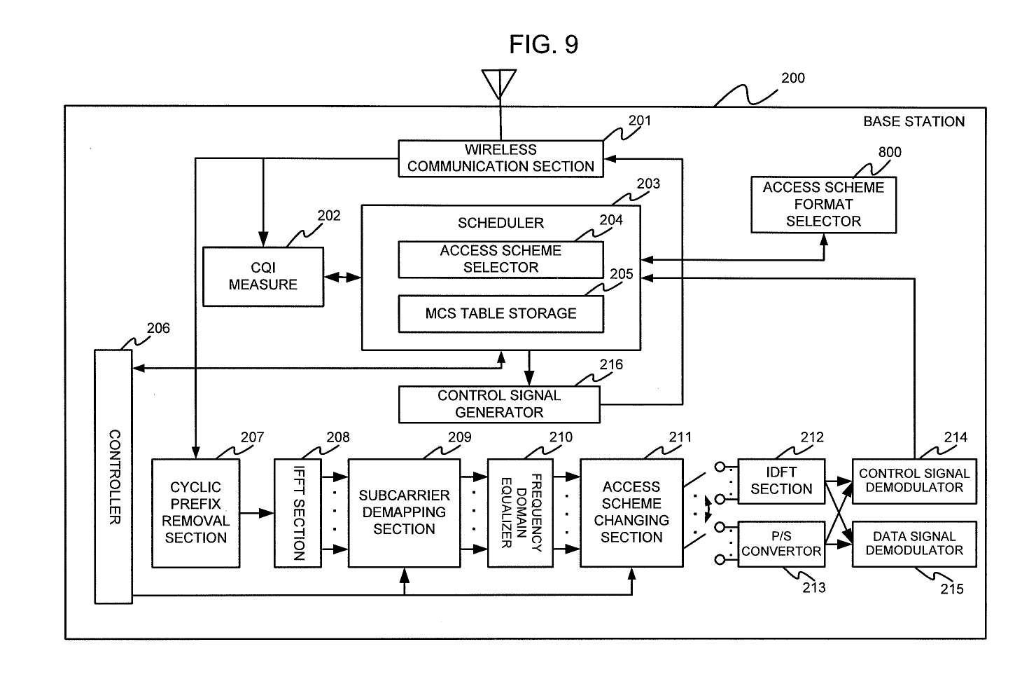

FIG. 9 schematically illustrates the configuration of a base station in a mobile wireless system in the second embodiment of the present invention. The same configuration elements as those of the first embodiment described with reference to FIG. 3 will be marked with the same reference numerals and description will be given to differences.

In the base station in the second embodiment, an access scheme format selector 800 is added. The access scheme format selector 800 sets the position of an allocated resource block (resource format) according to each access scheme. The resource format may be set at the time of factory shipment or may be appropriately set or updated at the time of installation or after installation. Referring to a set resource format, the scheduler 203 allocates a resource block to each mobile station with the access scheme taken into account. Information pertaining to the resource block allocation format determined by the access scheme format selector 800 is inputted to the control signal generator 216 and is broadcast to the mobile stations through the wireless communication section 201.

The general configuration of the LTE-A mobile station in the mobile wireless system in the second embodiment of the present invention is the same as that illustrated in FIG. 4. The second embodiment is different from the first embodiment in that: resource format information indicating the resource position allocated to each access scheme broadcast as a control signal is received through the wireless communication section 301 and extracted by the control information extraction section 302. Then the resource format information is inputted to the controller 303 and is used to control the access scheme changing section 307.

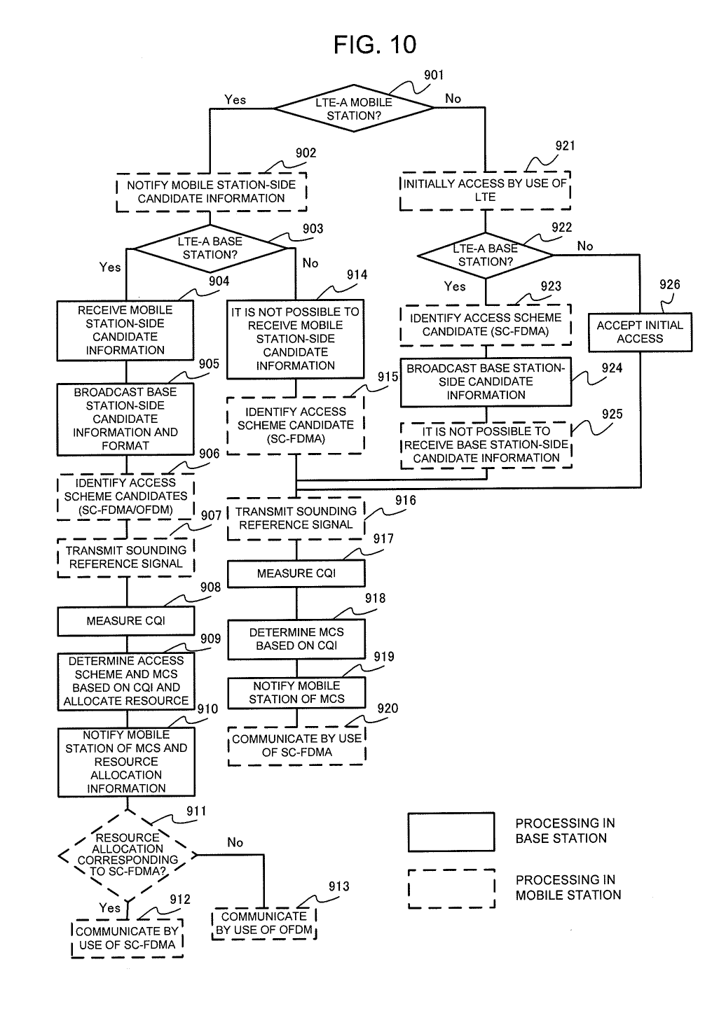

FIG. 10 illustrates the flow of operation of a base station and a mobile station in the second embodiment of the present invention.

First, description will be given to a case where an LTE-A mobile station communicates with a base station (Yes at Step 901).

In the initial accessing, the LTE-A mobile station generates mobile station-side candidate information at its control signal generator 305. The mobile station-side candidate information indicates access schemes (SC-FDMA and OFDM) with which the own mobile station (using, for example, PRACH (Physical Random Access Channel)) is compatible. Then the LTE-A mobile station notifies the base station of this information (Step 902). The mobile station candidate information need not be information indicating access schemes with which the relevant station is compatible. It may be information from which access schemes with which the mobile station is compatible is known, for example, mobile station class, the version of the system the mobile station supports, or the like.

Hereafter, description will be given to a case where the base station is an LTE-A base station (Yes at Step 903).

The scheduler 203 of the LTE-A base station receives the mobile station candidate information transmitted in the initial accessing. Then it identifies access schemes that can be used in communication between both the stations from this information and access schemes which itself can support (Step 904).

The LTE-A base station generates base station-side candidate information indicating access schemes with which the base station is compatible at the control signal generator 216. Then it broadcasts it together with a resource format indicating the position of a resource block allocated according to an access scheme using the following: PBCH (Physical Broadcast CHannel) or Higher layer signaling (mapped to PDSCH (Physical Downlink Shared CHannel) in the physical channel) (Step 905). The base station-side candidate information need not be information indicating access schemes with which the relevant station is compatible. It may be information from which access schemes with which the base station is compatible is known, for example, information pertaining to the version of the system the base station supports or the like.

The controller 303 of the LTE-A mobile station identifies the candidates of access schemes that can be used in communication between both the stations from the following: access schemes which itself supports and the base station-side candidate information transmitted by the LTE-A base station at Step 905 (Step 906). When the candidates of access schemes that can be used in communication between both the stations include multiple access schemes, the control information extraction section 302 extracts the resource format transmitted at Step 905.

When the LTE-A mobile station transmits data to the base station, it generates a sounding reference signal at the reference signal generator 306 and transmits it to the LTE-A base station (Step 907). The CQI measure 202 of the LTE-A base station receives the sounding reference signal from the LTE-A mobile station and measures the CQI of the LTE-A mobile station (Step 908).

The scheduler 203 of the LTE-A base station determines an access scheme using the CQI measured by the CQI measure 202 at Step 907. Thereafter, it selects a modulation scheme and an encoding ratio (MCS) and allocates a resource block corresponding to the resource format allocated according to the access scheme (Step 909). At this time, the controller 206 controls the access scheme changing section 211 according to the determined access scheme. That is, it controls the access scheme changing section 211 to change the circuitry so that the following is implemented: data is outputted to the IDFT section 212 when SC-FDMA is used and is outputted to the P/S convertor 213 when OFDM is used.

The control signal generator 216 of the LTE-A base station generates MCS control information and resource block allocation information and notifies the LTE-A mobile station of them (Step 910).

The control information extraction section 302 of the LTE-A mobile station extracts an

MCS control signal and resource block allocation information from the received control information. Then it determines whether or not the resource block corresponds to SC-FDMA based on the position of the resource block indicated by the extracted resource block allocation information (Step 911).

When an affirmative judgment is made at Step 911, the controller 303 controls the access scheme changing section 307 so that data is outputted to the DFT section 308. Then it transmits data by SC-FDMA using the MCS extracted by the control information extraction section 302 at Step 911 (Step 912). When a negative judgment is made at Step 911, the controller 303 controls the access scheme changing section 307 so that data is outputted to the S/P convertor 309. Then it transmits data by OFDM using the MCS extracted by the control information extraction section 302 at Step 911 (Step 913).

Description will be given to a case where the base station is an LTE base station (No at Step 903).

The LTE base station does not carry out the processing of extracting mobile station-side candidate information contained in the signal transmitted in the initial accessing of the LTE-A mobile station (Step 914).

The LTE base station does not broadcast base station-side candidate information. Therefore, the controller 303 of the LTE-A mobile station that cannot receive the broadcast information identifies that it is located in the cell of the LTE base station. That is, it identifies that the access scheme candidate is SC-FDMA. Then it controls the access scheme changing section 307 so that data is outputted to the DFT section 308 (Step 915).

When the LTE-A mobile station transmits data, it generates a sounding reference signal at the reference signal generator 306 and transmits it (Step 916). The CQI measure 202 of the LTE base station receives the sounding reference signal from the LTE-A mobile station and measures CQI (Step 917).

The scheduler of the LTE base station determines MCS and allocates a resource block using the CQI measured at Step 917 (Step 918).

The control signal generator 216 of the LTE base station generates an MCS control signal and resource block allocation information and notifies the LTE-A mobile station of them (Step 919).

Last, the control information extraction section 302 of the LTE-A mobile station extracts the received MCS control signal and resource block allocation information. Then it transmits data by SC-FDMA using a modulation scheme and an encoding ratio brought into correspondence with the extracted MCS control signal (Step 920).

Description will be given to a case where an LTE mobile station communicates with a base station (No at Step 901).

The LTE mobile station accesses the base station in the initial accessing (Step 921). Description will be given to a case where the base station is an LTE-A base station (Yes at Step 922).

The scheduler 203 of the LTE-A base station receives a signal transmitted in the initial accessing of the LTE mobile station. Since mobile station-side candidate information is not contained in the signal, it identifies that the communication partner station is an LTE mobile station, that is, the access scheme candidate is SC-FDMA. Then the controller 206 controls the access scheme changing section 211 to change the circuitry so that data is outputted to the IDFT section 212 (Step 923).

The control signal generator 216 of the LTE-A base station generates base station-side candidate information in which the candidates of access schemes with which the LTE-A base station is compatible is described. Then it broadcasts the information together with a format for the band allocated according to an access scheme (Step 924).

The LTE mobile station cannot extract the signal broadcast by the LTE-A base station at Step 924 (Step 925).

Subsequently, the above-mentioned processing of Steps 916 to 920 is carried out.

Description will be given to a case where an LTE mobile station is located in the cell of an LTE base station (No at Step 922). In this case, communication is carried out between LTE stations and the LTE base station receives a signal transmitted in the initial accessing. The above-mentioned processing of Steps 916 to 920 is carried out.

In the above description, cases where an LTE-A mobile station transmits mobile station-side candidate information in the initial accessing have been taken as examples. Instead, mobile station-side candidate information can be transmitted before data is transmitted, for example, at the time of scheduling requesting, at the time of handover, or the like.

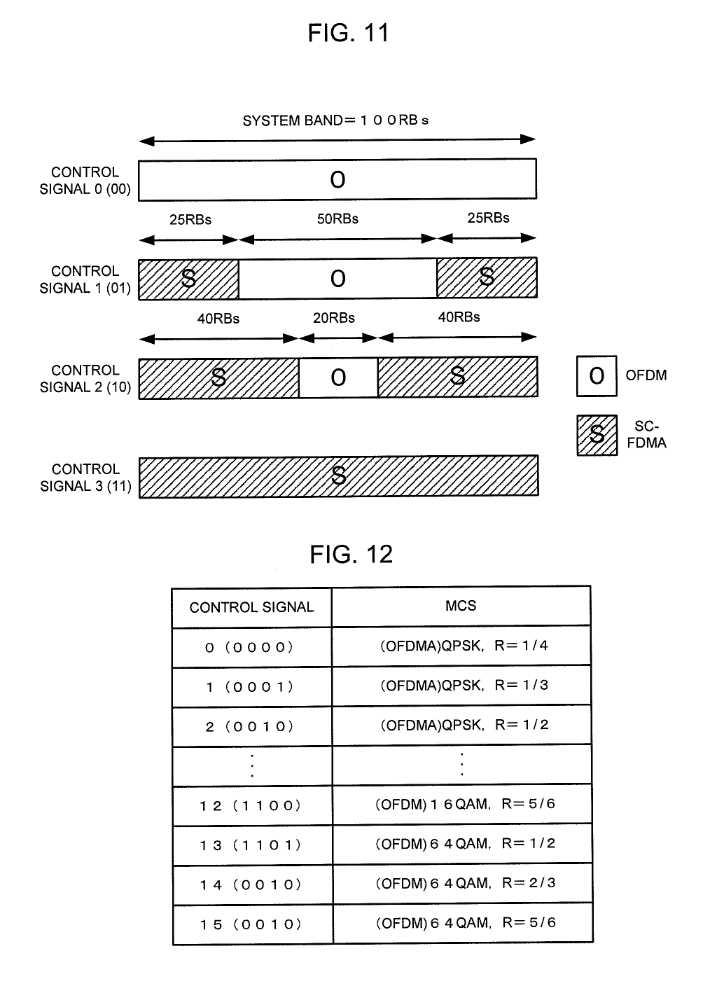

Description will be given to how to notify an allocation format for resource blocks allocated to access schemes in the second embodiment with reference to FIG. 11. In the example cited here, the number of resource blocks is 100 and two-bit resource formats are notified in four patterns as resource format notification information that uniquely indentifies resource formats.

For example, when 00 is notified in two bits, OFDM is used for all the resource blocks. When 01 is notified in two bits, OFDM is used for the 50 RBs in the center and SC-FDMA is used for the remaining 25 RBs, 50 RBs in total, at both ends. When 10 is notified in two bits, OFDM is used for the 20 RBs in the center and SC-FDMA is used for the remaining 40 RBs, 80 RBs in total, at both ends. When 11 is notified in two bits, SC-FDMA is used for all the resource blocks.

### EXAMPLE 3

Hereafter, description will be given to the MCS tables used in Example 3 in the second embodiment. In Example 3, different MCS tables are used from access scheme to access scheme identified by a mobile station. When communication is carried out by OFDM, the MCS table shown in FIG. 12 is used and when communication is carried out by SC-FDMA, the MCS table shown in FIG. 7 is used. The MCS table shown in FIG. 12 is based on the assumption that MCSs in 32 stages (4 bits) from 0 to 16 are used.

First, description will be given to a case where an LTE-A mobile station and an LTE-A base station communicate with each other. In this case, as shown in FIG. 14, the candidates of access schemes used in communication between the mobile station and the base station are SC-FDMA and OFDM. When the mobile station identifies that the position of a resource block allocated to itself indicates that communication is carried out by SC-FDMA, it uses the same MCS table of LTE as shown in FIG. 7. Meanwhile, when the mobile station identifies that the position of the resource block indicates that communication is carried out by OFDM, it uses such an MCS table as shown in FIG. 12, different from the MCS table (FIG. 7) used in SC-FDMA.

Description will be given to a case where communication is not between an LTE-A mobile station and an LTE-A base station. In this case, as shown in FIG. 14, the candidate of an access scheme used in communication between the mobile station and the base station is SC-FDMA. Therefore, the mobile station uses the MCS table (FIG. 7) used in SC-FDMA.

According to the second embodiment, the additional broadcast information is a control signal of several bits pertaining to a resource format. This makes it unnecessary to send additional control information pertaining to an access scheme used for each mobile station in each TTI and thus overhead can be reduced.

### Third Embodiment

In the second embodiment, the position on the frequency axis of a resource block allocated to each access scheme by a base station is preset. In the third embodiment, the following measure is taken: the position on the time axis of a resource block allocated to each access scheme by a base station is preset; and a mobile station determines an access scheme from the position of the allocated resource block. The scheduler of the base station allocates resource blocks with the access scheme of each mobile station taken into account.

The general configurations of the LTE-A base station and the LTE-A mobile station in the mobile wireless system in the third embodiment of the present invention are respectively identical with those illustrated in FIG. 9 and FIG. 4. Therefore, the same configuration elements will be marked with the same reference numerals and the detailed description thereof will be omitted.

The flow of operation of the base station and the mobile station in the third embodiment of the present invention is equivalent to that obtained by taking the following measure: the positions on the frequency axis of resource blocks allocated to access schemes in the second embodiment are replaced with the positions on the time axis of resource blocks allocated to access schemes. Therefore, the description thereof will be omitted.

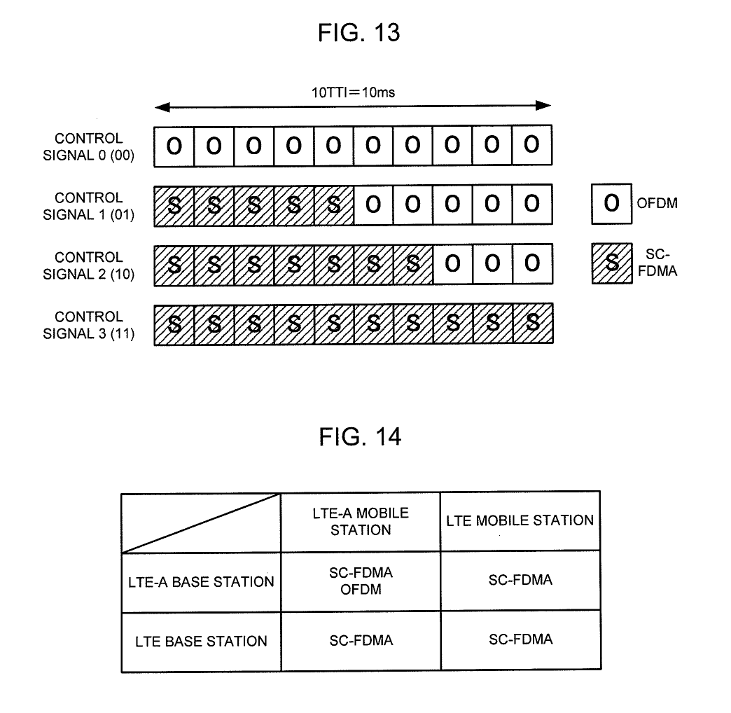

Description will be given to how to notify an allocation format for time frames allocated to access schemes in the third embodiment with reference to FIG. 13. In the example cited here, the number of time frames is 10 and two-bit resource formats are notified in four patterns as resource format notification information that uniquely identifies resource formats.

For example, when 00 is notified in two bits, OFDM is used for all the 10 time frames. When 01 is notified in two bits, SC-FDMA is used for the first five time frames and OFDM is used for the next five time frames. When 10 is notified in two bits, SC-FDMA is used for the first seven time frames and OFDM is used for the next three time frames. When 11 is notified in two bits, SC-FDMA is used for all the time frames.

According to the third embodiment, the additional broadcast information is a control signal of several bits pertaining to a resource format. This makes it unnecessary to send additional control information pertaining to an access scheme used for each mobile station in each TTI and thus overhead can be reduced.

### Fourth Embodiment

In the description of the fourth embodiment of the present invention, the following case will be taken as an example: a case where one MCS table compatible both with LTE and with LTE-A is held in an LTE-A base station and an LTE-A mobile station and access schemes are changed according to MCS control signals.

The base station and mobile station in this embodiment are substantially the same as those in the first embodiment described with reference to FIG. 3 and FIG. 4 and description will be given to differences.

The LTE-A mobile station and the LTE-A base station each hold one MCS table. The number of indexes in this MCS table is larger than the number of indexes of the MCS table used in LTE. MCSs added to the MCS table used in LTE and used in communication by OFDM are indicated in the additional index portion.

The flow of operation of the base station and the mobile station in the fourth embodiment is substantially the same as in the embodiment; therefore, description will be given with reference to FIG. 5.

First, description will be given to a case where an LTE-A mobile station communicates with a base station (Yes at Step 401).

When initially accessing the base station, the LTE-A mobile station generates mobile station-side candidate information at its control signal generator 305. The mobile station-side candidate information indicates access schemes (SC-FDMA, OFDM) with which the own mobile station (using, for example, PRACH (Physical Random Access CHannel)) is compatible. Then the LTE-A mobile station notifies the base station of this information (Step 402). The mobile station-side candidate information need not be information indicating access schemes with which the relevant mobile station is compatible. It may be information from which access schemes with which the mobile station is compatible is known, for example, information pertaining to mobile station class, the version of the system the mobile station can support, or the like. Hereafter, description will be given to a case where the base station is an LTE-A base station (Yes at Step 403).

The scheduler 203 of the LTE-A base station receives mobile station-side candidate information transmitted in the initial accessing. Then it identifies access schemes that can be used in communication between both the stations from this information and access schemes which itself can support. It identifies the index (MCS control signal) of which portion of the

MCS table it holds is used (Step 404). In this example, the access scheme candidates that can be used in communication between both the stations are SC-FDMA and OFDM and the LTE-A base station thereby identifies that all the indexes of the MCS table are used.

Subsequently, the LTE-A base station generates base station-side candidate information indicating access schemes with which the LTE-A base station is compatible at the control signal generator 216. Then it broadcasts this information using PBCH (Physical Broadcast Channel) or Higher layer signaling (mapped to PDSCH (Physical Downlink Shared CHannel) in the physical channel) (Step 405). The base station-side candidate information need not be information indicating access schemes with which the relevant base station is compatible. It may be information from which access schemes with which the base station can be compatible is known, for example, information pertaining to the version of the system the base station supports or the like.

The controller 303 of the LTE-A mobile station identifies the candidates of access schemes that can be used in communication between both the stations from the following: access schemes which itself can support and the base station-side candidate information transmitted by the LTE-A base station at Step 405. Then it identifies the index of which portion of the MCS table it holds is used (Step 406). In this example, the access scheme candidates that can be used in communication between both the stations are SC-FDMA and OFDM and the LTE-A mobile station thereby identifies that all the indexes of the MCS table are used.

When the LTE-A mobile station transmits data to the base station, it generates a sounding reference signal at the reference signal generator 306 and transmits it to the LTE-A base station (Step 407). The CQI measure 202 of the LTE-A base station receives the sounding reference signal from the LTE-A mobile station and measures the CQI of the LTE-A mobile station (Step 408).

The scheduler 203 of the LTE-A base station determines an access scheme, a modulation scheme and an encoding ratio from the CQI measured by the CQI measure 202 at Step 407 (Step 409). At this time, the controller 206 controls the access scheme changing section 211 according to the determined access scheme. That is, it controls the access scheme changing section 211 to change the circuitry so that the following is implemented: data is outputted to the IDFT section 212 when SC-FDMA is used and is outputted to the P/S convertor 213 when PFDM is used.

The control signal generator 216 of the LTE-A base station generates MCS control information in which the MCS determined at Step 409 and notifies the LTE-A mobile station of it (Step 410).

The controller 303 of the LTE-A mobile station determines whether or not the received MCS information is MCS corresponding to SC-FDMA using the received MCS information (Step 411).

When an affirmative judgment is made at Step 411, the controller 303 controls the access scheme changing section 307 so that data is outputted to the DFT section 308 and transmits data by SC-FDMA (Step 412). Meanwhile, when a negative judgment is made at Step 411, the controller 303 controls the access scheme changing section 307 so that data is outputted to the S/P convertor 309 and transmits data by OFDM (Step 413).

Description will be given to a case where the base station is an LTE base station (No at Step 403).

The LTE base station does not carry out the processing of extracting mobile station-side candidate information contained in the signal transmitted in the initial accessing of the LTE-A mobile station (Step 414).

The LTE base station does not broadcast base station-side candidate information. Therefore, the controller 303 of the LTE-A mobile station that cannot receive the information identifies that it is located in the cell of the LTE base station. That is, it identifies that the access scheme candidate is SC-FDMA. Then it identifies that in the MCS table it holds, only indexes of the portions corresponding to SC-FDMA are used. Further, it controls the access scheme changing section 307 so that data is outputted to the DFT section 308 (Step 415).

When the LTE-A mobile station transmits data, it generates a sounding reference signal at the reference signal generator 306 and transmits it (Step 416). The CQI measure 202 of the LTE base station receives the sounding reference signal from the LTE-A mobile station and measures CQI (Step 417).

The scheduler of the LTE base station determines MCS based on the MCS table of LTE using the CQI measured at Step 417 (Step 418).

The control signal generator 216 of the LTE base station generates MCS information in which the MCS determines at Step 418 is described and notifies the LTE-A mobile station of it (Step 419).

Last, the control information extraction section 302 of the LTE-A mobile station extracts the received MCS control signal. Then it transmits data by SC-FDMA using a modulation scheme and an encoding ratio brought into correspondence with the extracted MCS control signal (Step 420).

Description will be given to a case where an LTE mobile station communicates with a base station (No at Step 401).

The LTE mobile station accesses the base station in the initial accessing (Step 421). Description will be given to a case where the base station is an LTE-A base station (Yes at Step 422).

The scheduler 203 of the LTE-A base station receives a signal transmitted in the initial accessing of the LTE mobile station. Since mobile station-side candidate information is not contained in the signal, it identifies that the communication partner station is an LTE mobile station, that is, the access scheme candidate is SC-FDMA. Then it identifies that in the MCS table it holds, a portion corresponding to SC-FDMA is used. Further, the controller 206 controls the access scheme changing section 211 to change the circuitry so that data is outputted to the IDFT section 212 (Step 423).

The control signal generator 216 of the LTE-A base station generates base station-side candidate information in which the candidate of access schemes with which the LTE-A base station is compatible is described and broadcasts it to the mobile stations in its cell (Step 424).

The LTE mobile station cannot extract the signal broadcast by the LTE-A base station at Step 424 (Step 425).

Subsequently, the above-mentioned processing of Steps 416 to 420 is carried out.

Description will be given to a case where an LTE mobile station is located in the cell of an LTE base station (No at Step 422). In this case, communication is carried out between LTE stations and the LTE base station receives a signal transmitted in the initial accessing of the LTE mobile station. The above-mentioned processing of Steps 416 to 420 is carried out.

In the above description, cases where an LTE-A mobile station transmits mobile station-side candidate information in the initial accessing have been taken as examples. Instead, mobile station-side candidate information can be transmitted before data is transmitted, for example, at the time of scheduling requesting, at the time of handover, or the like.

### EXAMPLE 5

Description will be given to Example 5 in the fourth embodiment. It will be assumed that the MCS table used in LTE is in 16 stages (4 bits) from 0 to 15 as shown in FIG. 7. In the MCS table used in Example 5, as shown in FIG. 8, the control signals 0 to 15 are the same as those in the MCS table (FIG. 7) used in LTE; and the index portions of the control signals 16 to 31 (5 bits) are added.

First, description will be given to a case where an LTE-A mobile station and an LTE-A base station communicate with each other. In this case, as shown in FIG. 14, the access scheme candidate is SC-FDMA and OFDM. When the LTE-A base station and the LTE-A mobile station identify that the access scheme candidate is SC-FDMA and OFDM, it is identified that all the control signals of the MCS table are used. When the LTE-A base station determines to use SC-FDMA to communicate, it notifies any of MCS control signals 0 to 15; and when it determines to use OFDM to communicate, it notifies any of MCS control signals 16 to 31. In response thereto, the LTE-A mobile station uses SC-FDMA when the MCS control signal is any of 0 to 15. Meanwhile, it uses OFDM when the MCS control signal is any of 16 to 31.

Description will be given to a case where the communication is not between an LTE-A mobile station and an LTE-A base station. In this case, as shown in FIG. 14, the candidate of an access scheme used between both the stations is SC-FDMA. Therefore, a 4-bit MCS control signal indicating any of 0 to 15 is notified.

Use of the fourth embodiment makes it possible to change access schemes without change to MCS notification by LTE. Therefore, even in equipment so configured that either of a base station and a mobile station uses a single access scheme to communicate, communication can be carried out without problems.

Broadcast information minimum necessary for changing access schemes from mobile station to mobile station and down control information usually notified to individual mobile stations are brought into correspondence with each other to change access schemes. For this reason, any special notification pertaining to a new access scheme is not required and thus overhead can be reduced.

### Fifth Embodiment

In the description of the fifth embodiment of the present invention, a case where a mobile station determines an access scheme used in data communication with a base station will be taken as an example.

The base station and mobile station in this embodiment are substantially the same as those in the first embodiment described with reference to FIG. 3 and FIG. 4 and description will be given to differences.

When transmitting data to the base station, the controller 303 of the LTE-A mobile station determines an access scheme and MCS used in data transmission using at least any one of the following: the data amount of transmitted data, the probability of ACK/NACK to past up transmission, the measured propagation path quality of downlink, and the allocated bandwidth. At this time, the access scheme changing section 307 changes the circuitry so that data is outputted to the DFT section 308 or the S/P convertor 309 according to the determined access scheme.

The control signal generator 305 generates a control signal so as to transmit control information on the determined MCS by PUCCH or PUSCH. Then the subcarrier mapping section 310 modulates data and the control signal using the determined access scheme and MCS and the data and the control signal are transmitted to the base station through the wireless communication section 301.

The access scheme selector 204 of the LTE-A base station determines whether or not the received MCS control information is MCS corresponding to SC-FDMA using the received MCS control information and the MCS table selected at Step 404. When the received MCS control information is MCS corresponding to SC-FDMA, the controller 206 controls the access scheme changing section 211 so that data is outputted to the IDFT section 212. Meanwhile, when the received MCS control information is not MCS corresponding to SC-FDMA, the controller 206 controls the access scheme changing section 211 so that data is outputted to the P/S convertor 213.

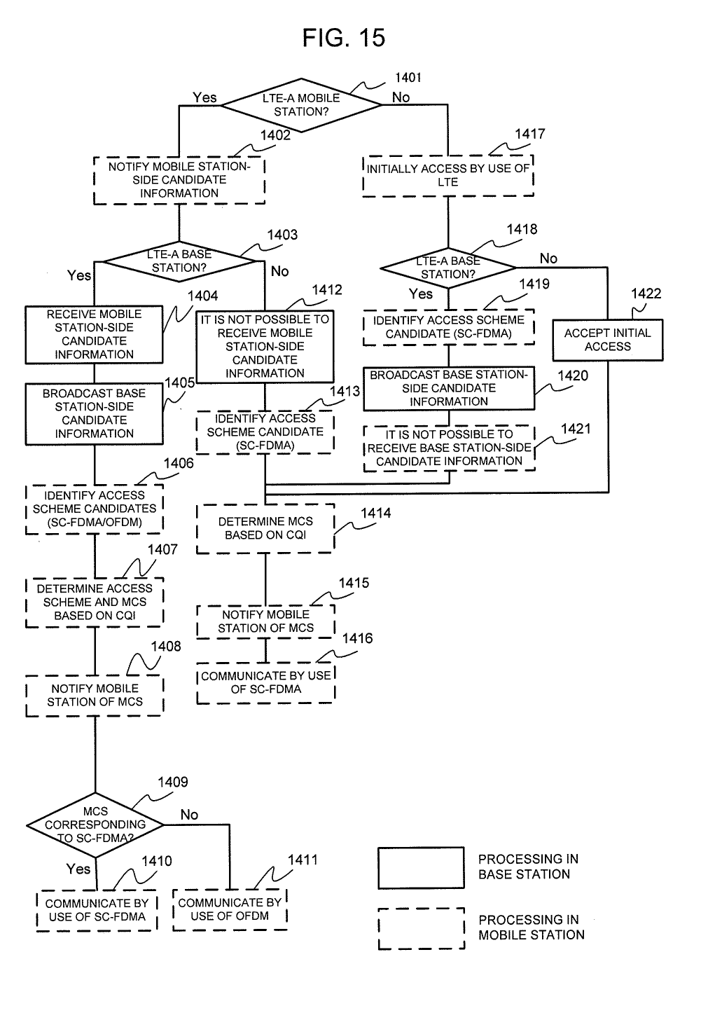

FIG. 15 illustrates the flow of operation of a base station and a mobile station in the fifth embodiment of the present invention.

First, description will be given to a case where an LTE-A mobile station communicates with a base station (Yes at Step 1401).

When initially accessing the base station, the LTE-A mobile station generates mobile station-side candidate information at its control signal generator 305. The mobile station-side candidate information indicates access schemes (SC-FDMA, OFDM) with which the own mobile station (using, for example, PRACH (Physical Random Access CHannel)) is compatible. Then the LTE-A mobile station notifies the base station of this information (Step 1402). The mobile station-side candidate information need not be information indicating access schemes with which the relevant station is compatible. It may be information from which access schemes with which the mobile station is compatible is known, for example, information pertaining to mobile station class, the version of the system the mobile station can support, or the like. Hereafter, description will be given to a case where the base station is an LTE-A base station (Yes at Step 1403).

The scheduler 203 of the LTE-A base station receives mobile station-side candidate information transmitted in the initial accessing. Then it identifies access schemes that can be used in communication between both the stations from this information and access schemes which itself can support and selects any one from among multiple MCS tables held by it (Step 1404). In this example, the access scheme candidates that can be used in communication between both the stations are SC-FDMA and OFDM and the LTE-A base station selects an MCS table thereby uniquely determined.

Subsequently, the LTE-A base station generates base station-side candidate information indicating access schemes with which the LTE-A base station is compatible at the control signal generator 216. Then it broadcasts this information using PBCH (Physical Broadcast CHannel) or Higher layer signaling (mapped to PDSCH (Physical Downlink Shared CHannel) in the physical channel) (Step 1405). The base station-side candidate information need not be information indicating access schemes with which the relevant base station is compatible. It may be information from which access schemes with which the base station is compatible is known, for example, information pertaining to the version of the system the base station supports or the like.

The controller 303 of the LTE-A mobile station identifies the candidates of access schemes that can be used in communication between both the stations from the following: access schemes which itself can support and the base station-side candidate information transmitted by the LTE-A base station at Step 405. Then it selects any one from among multiple MCS tables it holds (Step 1406). In this example, the access scheme candidates that can be used in communication between both the stations are SC-FDMA and OFDM and the LTE-A mobile station selects an MCS table thereby uniquely determined.

When transmitting data to the base station, the controller 303 of the LTE-A mobile station determines an access scheme and MCS used in data transmission using at least any one of the following: the data amount of transmitted data, the probability of ACK/NACK to past up transmission, the measured propagation path quality of downlink, and the allocated bandwidth (Step 1407). At this time, the access scheme changing section 307 changes the circuitry so that data is outputted to the DFT section 308 or the S/P convertor 309 according to the determined access scheme.

The control signal generator 305 generates a control signal so as to transmit control information on the determined MCS by PUCCH or PUSCH. Then the subcarrier mapping section 310 modulates data and the control signal using the determined access scheme and MCS and the data and the control signal are transmitted to the base station through the wireless communication section 301 (Step 1408).

The access scheme selector 204 of the LTE-A base station determines whether or not the received MCS control information is MCS corresponding to SC-FDMA using the received MCS control information and the MCS table selected at Step 404 (Step 1409).

When an affirmative judgment is made at Step 1409, the controller 206 controls the access scheme changing section 211 so that data is outputted to the IDFT section 212 and transmits data by SC-FDMA (Step 1410). Meanwhile, when a negative judgment is made at Step 1409, the controller 206 controls the access scheme changing section 211 so that data is outputted to the P/S convertor 213 and transmits data by OFDM (Step 1411).

Description will be given to a case where the base station is an LTE base station (No at Step 1403).

The LTE base station does not carry out the processing of extracting mobile station-side candidate information contained in the signal transmitted in the initial accessing of the LTE-A mobile station (Step 1412).

The LTE base station does not broadcast base station-side candidate information. Therefore, the controller 303 of the LTE-A mobile station that cannot receive the information identifies that it is located in the cell of the LTE base station. That is, it identifies that the access scheme candidate is SC-FDMA. Then it selects an MCS table corresponding to SC-FDMA from among the multiple MCS tables it holds. Further, it controls the access scheme changing section 307 so that data is outputted to the DFT section 308 (Step 1413).

When transmitting data to the base station, the controller 303 of the LTE-A mobile station determines MCS used in data transmission using at least any one of the following: the data amount of transmitted data, the probability of ACK/NACK to past up transmission, the measured propagation path quality of downlink, and the allocated bandwidth. Then the control signal generator 305 generates a control signal so as to transmit control information on the determined MCS by PUCCH or PUSCH (Step 1414).

The subcarrier mapping section 310 modulates data and the control signal using the determined MCS and the data and the control signal are transmitted to the base station by SC-FDMA through the wireless communication section 301 (Step 1415).

Last, the control information extraction section 302 of the LTE-A mobile station extracts the received MCS control signal. Then it transmits data by SC-FDMA using the modulation scheme and encoding ratio brought into correspondence with the extracted MCS control signal (Step 1416).

Description will be given to a case where an LTE mobile station communicates with a base station (No at Step 1401).

The LTE mobile station accesses the base station in the initial accessing (Step 1417). Description will be given to a case where the base station is an LTE-A base station (Yes at Step 1418).

The scheduler 203 of the LTE-A base station receives a signal transmitted in the initial accessing of the LTE mobile station. Since mobile station-side candidate information is not contained in the signal, it identifies that the station-on-the-other side of communication is an LTE mobile station, that is, the access scheme candidate is SC-FDMA. Then it selects an MCS table corresponding to SC-FDMA from among the multiple MCS tables it holds. Further, the controller 206 controls the access scheme changing section 211 to change the circuitry so that data is outputted to the IDFT section 212 (Step 1419).

The control signal generator 216 of the LTE-A base station generates base station-side candidate information in which the candidates of access schemes with which the LTE-A base station is compatible is described and broadcasts it to the mobile stations in its cell (Step 1420).

The LTE mobile station cannot extract the signal broadcast by the LTE-A base station at Step 424 (Step 1421).

Subsequently, the above-mentioned processing of Steps 1414 to 1416 is carried out.

Description will be given to a case where an LTE mobile station is located in the cell of an LTE base station (No at Step 1418). In this case, communication is carried out between LTE stations and the LTE base station receives a signal transmitted in the initial accessing of the LTE mobile station. The above-mentioned processing of Steps 1414 to 1416 is carried out.

In the above description, cases where an LTE-A mobile station transmits mobile station-side candidate information in the initial accessing have been taken as examples. Instead, mobile station-side candidate information can be transmitted before data is transmitted, for example, at the time of scheduling requesting, at the time of handover, or the like.

In the above description of this embodiment, cases where a control signal for MCS determined by an LTE-A mobile station is notified to an LTE-A base station. However, the invention may be so configured that an MCS control signal is not notified. In this case, the LTE-A base station selects an MCS table to be used based on mobile station-side candidate information; therefore, data is taken out by demodulating it by MCSs in all the patterns listed in the selected MCS table.

Use of the fifth embodiment makes it possible to change access schemes without change to MCS notification by LTE. Therefore, even in equipment so configured that either of a base station and a mobile station uses a single access scheme to communicate, communication can be carried out without problems.

Broadcast information minimum necessary for changing access schemes from mobile station to mobile station and down control information usually notified to individual mobile stations are brought into correspondence with each other to change access schemes. For this reason, any special notification pertaining to a new access scheme is not required and thus overhead can be reduced.

Since a mobile station determines MCS, it is unnecessary for a base station to notify the mobile station of MCS and overhead arising from down control information can be reduced.

In the above description, cases where two different kinds of access schemes, OFDM and SC-FDMA, are used have been taken as examples. However, the invention is not limited to this and an access scheme (designated as Clustered DFT-S-OFDM, N x DFT-S-OFDM, and the like) in which discontinuous resource allocation is applied to DFT-S-OFDM, CDMA, MC-CDMA, or the like is also applicable. Multiple kinds of access schemes are acceptable.

In the above description, a configuration used when an access scheme used when a mobile station transmits data (uplink) is determined has been taken as an example. Instead, the invention may be so configured that an access scheme used when a base station transmits data (downlink) is determined.

As is apparent from the above description, the above-mentioned terminals and base stations of the present invention can be configured by hardware. However, they can also be implemented by a computer program. In this case, the same functions and operation as in the above-mentioned embodiments are implemented by a processor that operates according to a program stored in a program memory. Some of the functions of the above-mentioned embodiments can also be implemented by a computer program.

Hereafter, description will be given to examples of the present invention.

A first example of the present invention is a communication system characterized in that using partner station candidate information that is control information in which information pertaining to access schemes with which a communication partner station is compatible is described, access schemes that can be used with said communication partner station are identified beforehand and any of said identified access schemes is determined during data communication as an access scheme to be used in said data communication with said communication partner station.

A second example of the present invention is characterized in that the first example is provided with a storage for storing a format in which control signal identification information indicating contents of transmission control in data transmission and an access scheme are brought into correspondence with each other for at least one of an access scheme and a combination of access schemes, and wherein said format is selected according to a result of said identification, and said communication partner station is notified of at least one of a control signal identifier brought into correspondence with said determined access scheme in said selected format and format information uniquely identifying said format.

A third example of the present invention is characterized in that, in the second example, said format is selected according to a result of said identification, and communication is carried out by means of an access scheme brought into correspondence with said notified control signal identification information in said selected format.

A fourth example of the present invention is characterized in that, in the second example or the third example, data in said data communication is received by means of said determined access scheme.

A fifth example of the present invention is characterized in that, in the second example or the third example, data in said data communication is transmitted by means of said determined access scheme.

A sixth example of the present invention is characterized in that, in any one of the second example to the fifth example, said storage stores a format in which MCS information uniquely identifying MCS (Modulation and Coding Scheme) and an access scheme are brought into correspondence with each other, and MCS information determined by using said selected format, at least one of communication environment and communication state, and said determined access scheme is notified.

A seventh example of the present invention is characterized in that, in any one of the second example to the fifth example, said storage stores a format in which allocation information indicating an allocated position of a resource block and an access scheme are brought into correspondence with each other, and allocation information determined by using said selected format, at least one of communication environment and communication state, and said determined access scheme is notified.

An eighth example of the present invention is characterized in that, in the seventh example, said allocation information is information indicating an allocated position of a resource block on a frequency axis.

A ninth example of the present invention is characterized in that, in the seventh example, said allocation information is information indicating an allocated position of a resource block on a time axis.

A tenth example of the present invention is characterized in that the first example is provided with a recording section for recording a table in which a control signal identifier indicating contents of transmission control in data transmission and an access scheme are brought into correspondence with each other, and wherein a control signal identifier brought into correspondence with said determined access scheme is retrieved, and said retrieved control signal identifier is notified to said communication partner station.

An eleventh example of the present invention is a terminal characterized in that using base station candidate information that is control information in which information pertaining to access schemes with which a base station is compatible is described, access schemes that can be used with said base station are identified beforehand, and using any access scheme of said identified access schemes, which is determined during data communication, data communication with said base station is carried out.

A twelfth example of the present invention is characterized in that the eleventh example is provided with a storage for storing a format in which control signal identification information indicating contents of transmission control in data transmission and an access scheme are brought into correspondence with each other for at least one of an access scheme and a combination of access schemes, and wherein said format is selected according to a result of said identification, and a control signal identifier transmitted from said base station is retrieved from said selected format, and communication is carried out using an access scheme brought into correspondence with said retrieved control signal identifier.

A thirteenth example of the present invention is characterized in that the eleventh example is provided with a storage for storing a format in which control signal identification information indicating contents of transmission control in data transmission and an access scheme are brought into correspondence with each other for at least one of an access scheme and a combination of access schemes, and wherein said format is selected according to a result of said identification, and a control signal identifier brought into correspondence with an access scheme determined at an own-station is retrieved from said selected format, and said retrieved control signal identifier is notified to said base station.

A fourteenth example of the present invention is characterized in that the eleventh example is provided with a storage for storing a format in which control signal identification information indicating contents of transmission control in data transmission and an access scheme are brought into correspondence with each other for at least one of an access scheme and a combination of access schemes, and wherein a format brought into correspondence with format information uniquely identifying said format, which is transmitted from said base station, is selected, and a control signal identifier transmitted from said base station is retrieved from said selected format, and communication is carried out using an access scheme brought into correspondence with said retrieved control signal identifier.

A fifteenth example of the present invention is characterized in that, in the twelfth example, said storage stores a format in which MCS information uniquely identifying MCS (Modulation and Coding Scheme) and an access scheme are brought into correspondence with each other, and MCS information determined by using said selected format, at least one of communication environment and communication state, and said determined access scheme is notified.

A sixteenth example of the present invention is characterized in that, in the fourteenth example, said storage stores a format in which allocation information indicating an allocated position of a resource block and an access scheme are brought into correspondence with each other, and allocation information transmitted from said base station is retrieved from said selected format, and communication is carried out using an access scheme brought into correspondence with said retrieved allocation information.

A seventeenth example of the present invention is characterized in that, in the sixteenth example, said allocation information is information indicating an allocated position of a resource block on a frequency axis.

An eighteenth example of the present invention is characterized in that, in the sixteenth example, said allocation information is information indicating an allocated position of a resource block on a time axis.

A nineteenth example of the present invention is characterized in that the eleventh example is provided with a recording section for recording a table in which a control signal identifier indicating contents of transmission control in data transmission and an access scheme are brought into correspondence with each other, and wherein a control signal identifier transmitted from said base station is retrieved from said table, and communication is carried out by means of an access scheme brought into correspondence with said retrieved control signal identifier.

A twentieth example of the present invention is a base station characterized in that using mobile station candidate information that is control information in which information pertaining to access schemes with which a mobile station is compatible is described, access schemes that can be used with said mobile station are identified beforehand, and using any access scheme of said identified access schemes, which is determined during data communication, data communication with said mobile station is carried out.

A twenty-first example of the present invention is characterized in that the twentieth example is provided with a storage for storing a format in which control signal identification information indicating contents of transmission control in data transmission and an access scheme are brought into correspondence with each other for at least one of an access scheme and a combination of access schemes, and wherein said format is selected according to a result of said identification, and a control signal identifier brought into correspondence with an access scheme determined at an own-station is retrieved from said selected format, and said mobile station is notified of at least one of said retrieved control signal identifier and format information uniquely identifying said selected format.

A twenty-second example of the present invention is characterized in that, in the twentieth example, said format is selected according to a result of said identification, and control signal identification information transmitted from said mobile station is retrieved from said selected format, and communication is carried out by means of an access scheme brought into correspondence with said retrieved control signal identification information.

A twenty-third example of the present invention is characterized in that, in the twenty-first example, said storage stores a format in which MCS information uniquely identifying MCS (Modulation and Coding Scheme) and an access scheme are brought into correspondence with each other, and MCS information determined by using said selected format, at least one of communication environment and communication state, and said determined access scheme is notified to said mobile station.

A twenty-fourth example of the present invention is characterized in that, in the twenty-first example, said storage stores a format in which allocation information indicating an allocated position of a resource block and an access scheme are brought into correspondence with each other, and any format in said storage is selected using an access scheme and allocation information determined at an own-station, and said mobile station is notified of format information on said selected format and said determined allocation information.

A twenty-fifth example of the present invention is characterized in that, in the twenty-fourth example, said allocation information is information indicating an allocated position of a resource block on a frequency axis.

A twenty-sixth example of the present invention is characterized in that, in the twenty-fourth example, said allocation information is information indicating an allocated position of a resource block on a time axis.

A twenty-seventh example of the present invention is characterized in that the twentieth example is provided with a recording section for recording a table in which a control signal identifier indicating contents of transmission control in data transmission and an access scheme are brought into correspondence with each other, and wherein a control signal identifier transmitted from said mobile station is retrieved from said table, and communication is carried out by means of an access scheme brought into correspondence with said retrieved control signal identifier.

A twenty-eighth example of the present invention is a communication method characterized in that using partner station candidate information that is control information in which information pertaining to access schemes with which a communication partner station is compatible is described, access schemes that can be used with said communication partner station are identified beforehand, and any of said identified access schemes is determined during data communication as an access scheme to be used in said data communication with said communication partner station.

A twenty-ninth example of the present invention is characterized in that, in the twenty-eighth example, any of formats in which control signal identification information indicating contents of transmission control in data transmission and an access scheme are brought into correspondence with each other for at least one of an access scheme and a combination of access schemes is selected according to a result of said identification, and said communication partner station is notified of at least one of a control signal identifier brought into correspondence with said determined access scheme in said selected format and format information uniquely identifying said format.

A thirtieth example of the present invention is characterized in that, in the twenty-eighth example, said format is selected according to a result of said identification, and communication is carried out by means of an access scheme brought into correspondence with said notified control signal identification information in said selected format.

A thirty-first example of the present invention is characterized in that, in the twenty-eighth example or the thirtieth example, data in said data communication is received by means of said determined access scheme.

A thirty-second example of the present invention is characterized in that, in the twenty-ninth example or the thirtieth example, data in said data communication is transmitted by means of said determined access scheme.

A thirty-third example of the present invention is characterized in that, in any of the twenty-ninth example to the thirty-second example, MCS information is notified, which is determined by using a format selected from formats in which MCS information uniquely identifying MCS (Modulation and Coding Scheme) and an access scheme are brought into correspondence with each other for at least one of an access scheme and a combination of access schemes, at least one of communication environment and communication state, and said determined access scheme.

A thirty-fourth example of the present invention is characterized in that, in any of the twenty-ninth example to the thirty-second example, allocation information is notified, which is determined by using a format selected from formats in which allocation information indicating an allocated position of a resource block and an access scheme are brought into correspondence with each other for at least one of an access scheme and a combination of access schemes, at least one of communication environment and communication state, and said determined access scheme.

A thirty-fifth example of the present invention is characterized in that, in the thirty-fourth example, said allocation information is information indicating an allocated position of a resource block on a frequency axis.

A thirty-sixth example of the present invention is characterized in that, in the thirty-fourth example, said allocation information is information indicating an allocated position of a resource block on a time axis.

A thirty-seventh example of the present invention is characterized in that, in the twenty-eighth example, a control signal identifier brought into correspondence with said determined access scheme is retrieved from a recording section for recording a table in which a control signal identifier indicating contents of transmission control in data transmission and an access scheme are brought into correspondence with each other, and said retrieved control signal identifier is notified to said communication partner station.

A thirty-eighth example of the present invention is a program of a terminal, characterized in that said program causes said terminal to function to, using base station candidate information that is control information in which information pertaining to access schemes with which a base station is compatible is described, identify beforehand access schemes that can be used with said base station, and using any access scheme of said identified access schemes, which is determined during data communication, carry out data communication with said base station.

A thirty-ninth example of the present invention is a program of a base station, characterized in that said program causes said base station to function to, using mobile station candidate information that is control information in which information pertaining to access schemes with which a mobile station is compatible is described, identify beforehand access schemes that can be used with said mobile station, and using any access scheme of said identified access schemes, which is determined during data communication, carry out data communication with said mobile station.

Up to this point, the present invention has been described based on embodiments and examples. However, the present invention is not limited to the above embodiments or examples and can be variously modified without departing from the scope of the technical idea thereof.

The present application claims the priority based on Japanese Patent Application No. 2008-299044 filed on Nov. 25, 2008, the disclosure of which is incorporated herein in its entirety.

### INDUSTRIAL APPLICABILITY

The present invention is generally applicable to mobile wireless systems that support multiple access schemes.

1. A communication system wherein using partner station candidate information that is control information in which information pertaining to access schemes with which a partner station of communication is compatible is described, access schemes that can be used with said communication partner station are identified beforehand and any of said identified access schemes is determined during data communication as an access scheme to be used in said data communication with said communication partner station.

2. A communication system according to claim 1, comprising a storage for storing a format in which control signal identification information indicating contents of transmission control in data transmission and an access scheme are brought into correspondence with each other for at least one of an access scheme and a combination of access schemes, and
wherein said format is selected according to a result of said identification, and said communication partner station is notified of at least one of a control signal identifier brought into correspondence with said determined access scheme in said selected format and format information uniquely identifying said format.

3. A communication system according to claim 2, wherein said format is selected according to a result of said identification, and communication is carried out by means of an access scheme brought into correspondence with said notified control signal identification information in said selected format.

4. A communication system according to claim 2, wherein data in said data communication is received by means of said determined access scheme.

5. A communication system according to claim 2, wherein data in said data communication is transmitted by means of said determined access scheme.

6. A communication system according to claim 2, wherein said storage stores a format in which MCS information uniquely identifying MCS (Modulation and Coding Scheme) and an access scheme are brought into correspondence with each other, and
MCS information determined by using said selected format, at least one of communication environment and communication state, and said determined access scheme is notified.

7. A communication system according to claim 2, wherein said storage stores a format in which allocation information indicating an allocated position of a resource block and an access scheme are brought into correspondence with each other, and
allocation information determined by using said selected format, at least one of communication environment and communication state, and said determined access scheme is notified.

8. A communication system according to claim 7, wherein said allocation information is information indicating an allocated position of a resource block on a frequency axis.

9. A communication system according to claim 7, wherein said allocation information is information indicating an allocated position of a resource block on a time axis.

10. A communication system according to claim 1, comprising a recording section for recording a table in which a control signal identifier indicating contents of transmission control in data transmission and an access scheme are brought into correspondence with each other, and
wherein a control signal identifier brought into correspondence with said deter mined access scheme is retrieved, and said retrieved control signal identifier is notified to said communication partner station.

11. A terminal wherein using base station candidate information that is control information in which information pertaining to access schemes with which a base station is compatible is described, access schemes that can be used with said base station are identified beforehand, and using any access scheme of said identified access schemes, which is determined during data communication, data communication with said base station is carried out.

12. A terminal according to claim 11, comprising a storage for storing a format in which control signal identification information indicating contents of transmission control in data transmission and an access scheme are brought into correspondence with each other for at least one of an access scheme and a combination of access schemes, and
wherein said format is selected according to a result of said identification, and a control signal identifier transmitted from said base station is retrieved from said selected format, and communication is carried out using an access scheme brought into correspondence with said retrieved control signal identifier.

13. A terminal according to claim 11, comprising a storage for storing a format in which control signal identification information indicating contents of transmission control in data transmission and an access scheme are brought into correspondence with each other for at least one of an access scheme and a combination of access schemes, and
wherein said format is selected according to a result of said identification, and a control signal identifier brought into correspondence with an access scheme determined at an own-station is retrieved from said selected format, and said retrieved control signal identifier is notified to said base station.

14. A terminal according to claim 11, comprising a storage for storing a format in which control signal identification information indicating contents of transmission control in data transmission and an access scheme are brought into correspondence with each other for at least one of an access scheme and a combination of access schemes, and
wherein a format brought into correspondence with format information uniquely identifying said format, which is transmitted from said base station, is selected, and a control signal identifier transmitted from said base station is retrieved from said selected format, and communication is carried out using an access scheme brought into correspondence with said retrieved control signal identifier.

15. A terminal according to claim 12, wherein said storage stores a format in which MCS information uniquely identifying MCS (Modulation and Coding Scheme) and an access scheme are brought into correspondence with each other, and
MCS information determined by using said selected format, at least one of communication environment and communication state, and said determined access scheme is notified.

16. A terminal according to claim 14, wherein said storage stores a format in which allocation information indicating an allocated position of a resource block and an access scheme are brought into correspondence with each other, and
allocation information transmitted from said base station is retrieved from said selected format, and communication is carried out using an access scheme brought into correspondence with said retrieved allocation information.

17. A terminal according to claim 16, wherein said allocation information is information indicating an allocated position of a resource block on a frequency axis.

18. A terminal according to claim 16, wherein said allocation information is information indicating an allocated position of a resource block on a time axis.

19. A terminal according to claim 11, comprising a recording section for recording a table in which a control signal identifier indicating contents of transmission control in data transmission and an access scheme are brought into correspondence with each other, and
wherein a control signal identifier transmitted from said base station is retrieved from said table, and communication is carried out by means of an access scheme brought into correspondence with said retrieved control signal identifier.

20. A base station wherein using mobile station candidate information that is control information in which information pertaining to access schemes with which a mobile station is compatible is described, access schemes that can be used with said mobile station are identified beforehand, and using any access scheme of said identified access schemes, which is determined during data communication, data communication with said mobile station is carried out.

21. A base station according to claim 20, comprising a storage for storing a format in which control signal identification information indicating contents of transmission control in data transmission and an access scheme are brought into correspondence with each other for at least one of an access scheme and a combination of access schemes, and
wherein said format is selected according to a result of said identification, and a control signal identifier brought into correspondence with an access scheme determined at an own-station is retrieved from said selected format, and said mobile station is notified of at least one of said retrieved control signal identifier and format information uniquely identifying said selected format.

22. A base station according to claim 20, wherein said format is selected according to a result of said identification, and control signal identification information transmitted from said mobile station is retrieved from said selected format, and communication is carried out by means of an access scheme brought into correspondence with said retrieved control signal identification information.

23. A base station according to claim 21, wherein said storage stores a format in which MCS information uniquely identifying MCS (Modulation and Coding Scheme) and an access scheme are brought into correspondence with each other, and
MCS information determined by using said selected format, at least one of communication environment and communication state, and said determined access scheme is notified to said mobile station.

24. A base station according to claim 21, wherein said storage stores a format in which allocation information indicating an allocated position of a resource block and an access scheme are brought into correspondence with each other, and
any format in said storage is selected using an access scheme and allocation information determined at an own-station, and said mobile station is notified of format information on said selected format and said determined allocation information.

25. A base station according to claim 24, wherein said allocation information is information indicating an allocated position of a resource block on a frequency axis.

26. A base station according to claim 24, wherein said allocation information is information indicating an allocated position of a resource block on a time axis.

27. A terminal according to claim 20, comprising a recording section for recording a table in which a control signal identifier indicating contents of transmission control in data transmission and an access scheme are brought into correspondence with each other, and
wherein a control signal identifier transmitted from said mobile station is retrieved from said table, and communication is carried out by means of an access scheme brought into correspondence with said retrieved control signal identifier.

28. A communication method wherein using partner station candidate information that is control information in which information pertaining to access schemes with which a communication partner station is compatible is described, access schemes that can be used with said communication partner station are identified beforehand, and
any of said identified access schemes is determined during data communication as an access scheme to be used in said data communication with said communication partner station.

29. A communication method according to claim 28, wherein any of formats in which control signal identification information indicating contents of transmission control in data transmission and an access scheme are brought into correspondence with each other for at least one of an access scheme and a combination of access schemes is selected according to a result of said identification, and said communication partner station is notified of at least one of a control signal identifier brought into correspondence with said determined access scheme in said selected format and format information uniquely identifying said format.

30. A communication method according to claim 29, wherein said format is selected according to a result of said identification, and communication is carried out by means of an access scheme brought into correspondence with said notified control signal identification information in said selected format.

31. A communication method according to claim 29, wherein data in said data communication is received by means of said determined access scheme.

32. A communication method according to claim 29, wherein data in said data communication is transmitted by means of said determined access scheme.

33. A communication method according to claim 29, wherein MCS information is notified, which is determined by using a format selected from formats in which MCS information uniquely identifying MCS (Modulation and Coding Scheme) and an access scheme are brought into correspondence with each other for at least one of an access scheme and a combination of access schemes, at least one of communication environment and communication state, and said determined access scheme.

34. A communication method according to claim 29, wherein allocation information is notified, which is determined by using a format selected from formats in which allocation information indicating an allocated position of a resource block and an access scheme are brought into correspondence with each other for at least one of an access scheme and a combination of access schemes, at least one of communication environment and communication state, and said determined access scheme.

35. A communication method according to claim 34, wherein said allocation information is information indicating an allocated position of a resource block on a frequency axis.

36. A communication method according to claim 34, wherein said allocation information is information indicating an allocated position of a resource block on a time axis.

37. A communication method according to claim 28, wherein a control signal identifier brought into correspondence with said determined access scheme is retrieved from a recording section for recording a table in which a control signal identifier indicating contents of transmission control in data transmission and an access scheme are brought into correspondence with each other, and said retrieved control signal identifier is notified to said communication partner station.

38. A program of a terminal, causing said terminal to function to, using base station candidate information that is control information in which information pertaining to access schemes with which a base station is compatible is described, identify beforehand access schemes that can be used with said base station, and using any access scheme of said identified access schemes, which is determined during data communication, carry out data communication with said base station.

39. A program of a base station, causing said base station to function to, using mobile station candidate information that is control information in which information pertaining to access schemes with which a mobile station is compatible is described, identify beforehand access schemes that can be used with said mobile station, and using any access scheme of said identified access schemes, which is determined during data communication, carry out data communication with said mobile station.
